(19) United States
(12) Patent Application Publication
(10) Pub. No.: US 2010/0001086 A1
(43) Pub. Date: Jan. 7, 2010

(54) Comfort heating system for motor vehicle

(76) Inventors: Mohinder S. Bhatti, Williamsville, NY (US); Mark J. Zima, Clarence Center, NY (US); Prasad S. Kadle, Williamsville, NY (US)

Correspondence Address: Delphi Technologies, Inc., M/C 480-410-202, PO BOX 5052, Troy, MI, 48007, US

(21) Appl. No.: 12/217,531

(22) Filed: Jul. 7, 2008

(51) Int. Cl. B60H 1/02

(52) U.S. Cl. 237/6; 237/8 B; 237/9 R

(57) ABSTRACT

A method for heating ambient air for a passenger compartment of a motor vehicle is disclosed herein. The method includes the step of positioning a first heat exchanger proximate to a passenger compartment of a vehicle. The method also includes the step of passing ambient air for the passenger compartment through a first heat exchanger. The method also includes the step of concurrently directing distinct flows of engine coolant and steam to the first heat exchanger to heat the ambient air.

### BACKGROUND OF THE INVENTION

1. Field of the Invention

The invention relates to a comfort heating system for a motor vehicle.

2. Description of Related Prior Art

The most commonly used comfort heating system of a motor vehicle comprises a heater core, which is located inside the heating, ventilating and air conditioning (HVAC) module. The heater core is a liquid-to-air heat exchanger deriving thermal energy from the engine coolant. Approximately, one third of the thermal energy generated in the internal combustion engine of the motor vehicle is removed by the engine coolant for dissipation at the radiator in front of the vehicle. In winter time, a fraction of the hot engine coolant is diverted to the heater core. The cold ambient air flowing over the heater core extracts thermal energy from the engine coolant and blows it into the passenger compartment to provide comfort to the passengers.

With the advent of more efficient internal combustion engines, the available amount of thermal energy for comfort heating from the engine coolant is reduced creating a need for auxiliary heaters. Various types of auxiliary heaters being considered to operate in conjunction with the conventional heater core include electric resistance heater, thermoelectric heater, solid phase change heater, gasoline heater and exhaust gas heater. The subject invention falls into the category of engine coolant heater operating in conjunction with an exhaust gas heater.

A complete account of the evolution of the motor vehicle heating systems is presented in the following paper published in the Journal of American Society of Heating Refrigerating and Air Conditioning Engineers (ASHRAE): M. S. Bhatti, Riding in Comfort: Part I, Evolution of Automotive Heating, Volume 41, Number 8, pp 51-57, August 1999. According to this publication, the early automobiles were like horse-drawn carriages except that they were powered by electric batteries or gasoline engines. Referred to as “Horseless Carriages”, they were open-body vehicles offering no protection from the elements. Closed-body vehicles did not make their appearance until 1908 when attention turned to comfort heating devices like heated soapstones, bricks and lanterns that were used in the horse-drawn carriages. As interest in motoring continued to increase, portable coal-burning heaters were developed.

Since the aforementioned heating aids required special preparation preparatory to motoring, attention turned to the use of on-board heat source namely exhaust gas for comfort heating as indicated in the U.S. Pat. No. 1,585,951. The early exhaust gas heaters were in the form of footrests that could be mounted on the rear compartment floor. They were like radiators made of a bundle of tubes through which passed the exhaust gas. There were numerous problems with the early exhaust gas heaters including leakage of the toxic exhaust gas resulting in death. Since the early closed-body automobiles were not air-tight, the number of deaths resulting from exhaust gas leakage was not too alarming. Gradual improvements in the exhaust gas heaters led to the introduction of the dash-mounted exhaust gas heaters with double header construction to minimize exhaust gas leakage during 1920s.

In the mid 1920s, the exhaust gas heaters were replaced by the safer hot water heaters, which derive thermal energy from the engine coolant. The engine coolant in the early vehicles was water and accordingly the early hot water heaters used water as the working fluid. An example of early hot water heaters can be found in the U.S. Pat. No. 1,923,355. Starting in 1929, the motor vehicles started using a solution of 50% ethylene glycol and 50% water as the engine coolant and accordingly starting in 1930s the hot water heaters started using this new engine coolant as the working fluid. The early hot water heaters were dash-mounted units. With the advent of the four-season climate control system, a need was felt to combine comfort heating and cooling systems in a motor vehicle. Accordingly, starting in 1963, the heater core was moved to its current location near the evaporator of the air conditioning system inside the HVAC module. The U.S. Pat. No. 3,004,752 describes an integrated automotive heating and air conditioning system.

Today with improvements in the internal combustion engines the amount of thermal energy available to provide comfort heating in a gasoline-powered vehicle is not adequate. Accordingly, attention is turning to use exhaust gas as a heat source to supplement the thermal energy available from the engine coolant. The U.S. Pat. No. 2,212,250 describes an exhaust gas booster heater using engine coolant as the working fluid. Based on past experience with exhaust gas heaters, the thermal energy from the toxic exhaust gas must be extracted in a safe manner as in the subject invention where the exhaust gas is prevented from entering the passenger compartment.

### SUMMARY OF THE INVENTION

In summary, the invention represents a high performance comfort heating system for a motor vehicle. It derives thermal energy for comfort heating from the engine coolant as well as from the exhaust gas in a safe manner. The thermal energy from the engine coolant directly enters the heating system with engine coolant as the working fluid. The thermal energy from the exhaust gas indirectly enters the heating system with steam—generated by the exhaust gas—as the working fluid. The system comprises a first heat exchanger positioned proximate to the passenger compartment of a motor vehicle. It also comprises a second heat exchanger located between the catalytic converter and the muffler to generate steam, which is directed to the first heat exchanger by thermosiphon action without the aid of a pumping device such as a pump or a blower. A coolant circulation pump incorporated in the engine cooling loop of the vehicle directs hot coolant from the engine block to the first heat exchanger. A blower blows the ambient air through the first heat exchanger into the passenger compartment of the vehicle thereby extracting heat from the engine coolant as well as from the steam for comfort heating

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a schematic illustration of a steam heating system for a vehicle according to the exemplary embodiment of the invention;

FIG. 2 is a schematic illustration of an exemplary vehicle heater for the steam heating system shown in FIG. 1;

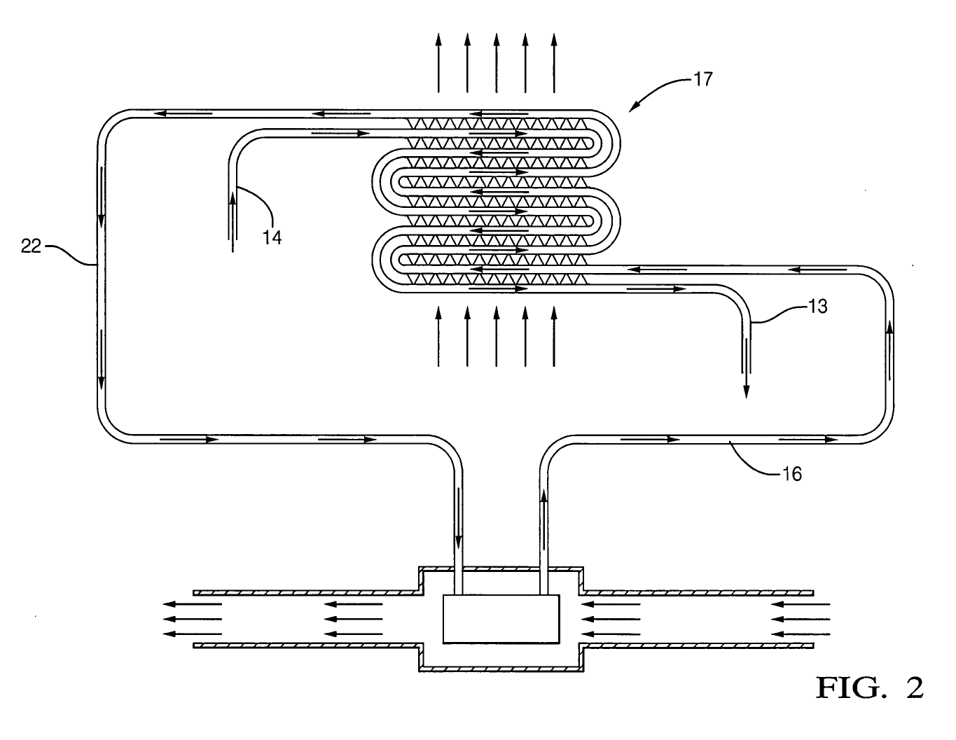

FIG. 3 is a cross-sectional view of an exhaust gas heater for the steam heating system shown in FIG. 1; and

FIG. 4 is a graph representing the heating cooling cycle on the pressure enthalpy diagram.

### DETAILED DESCRIPTION OF THE EXEMPLARY EMBODIMENT

A working example of the invention can be understood with the aid of the Figures. Components of a steam heating system include an exhaust gas heater 21, a vehicle heater 17, a radiator 3, and shutoff valves 11 and 12.

The vehicle heater 17 can be disposed in a passenger compartment 18, adjacent a fire wall 15. The vehicle heater 17 can be a three-fluid heat exchanger entailing a flow of steam, a flow of engine coolant in the interior, and a flow of ambient air on the exterior. An engine 1 having a fan 4 and a valve cover 7 can be disposed on the opposite side of the fire wall 15, in an engine compartment 10. Coolant flows between the radiator 3 and an engine cylinder head 8 through passageways 2 and 6.

An embodiment of the vehicle heater 17 comprises a pair of flat nested serpentine tubes with convoluted louvered fins sandwiched between the flat portions of the tubes. The engine coolant flows into the heater 17 from a passageway 14 communicating with the radiator 3 and back to the radiator 3 through a passageway 13. The steam flows into the heater 17 from the exhaust gas heater 21 through a passageway 16 and back to the exhaust gas heater 21 through a passageway 22.

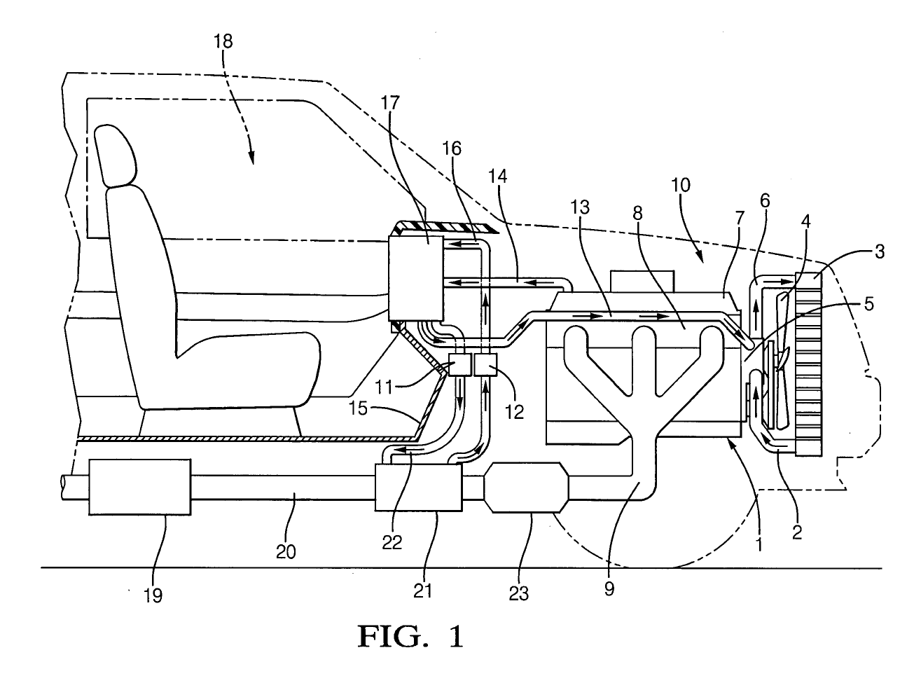

The flows of coolant and steam through the heater 17 are counter current in fashion to enhance the heat transfer rate between the two fluids. The ambient air flows on the exterior of the vehicle heater 17 in a cross flow pattern through the convoluted louvered fins abstracting heat both from the engine coolant as well as from the steam. The hot engine coolant enters the vehicle heater 17 from the engine cylinder head 8 shown in FIG. 1 while the hot steam enters the vehicle heater 17 from the exhaust gas heater 21 shown in FIG. 1. The steam is heated by exhaust gases flowing to the exhaust gas heater 21 from an exhaust manifold 9 communicating with the engine cylinder head 8. Thus the vehicle heater draws heat from two sources—the engine block and the exhaust gas.

In an alternate embodiment of the vehicle heater 17, the steam serpentine tube can be an array of flat tubes secured by a pair of slotted headers onto which can be clinched a pair of tanks. The bends of the coolant serpentine tube formed by an array of hairpins in such an embodiment run through the aforementioned pair of slotted headers. In such an embodiment, the steam pressure drop in the vehicle heater is reduced. This is an important consideration on the steam side of the vehicle heater since there may be no pumping device on the steam side and the steam flow may occur by thermosiphon action alone. On the coolant side of the vehicle heater 17, the coolant flow can be propelled by a coolant pump 5 and as such more pressure drop can be tolerated.

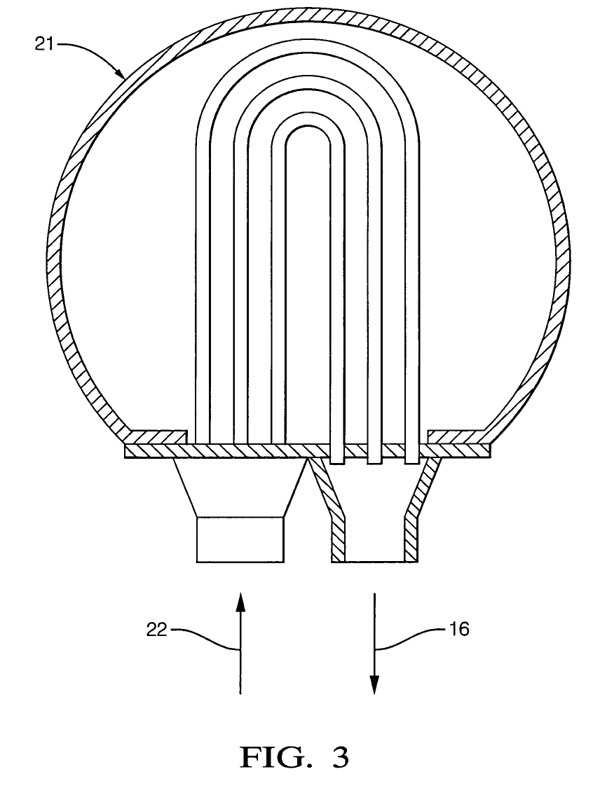

FIG. 3 shows an embodiment of the exhaust gas heater 21 comprising an array of nested U-tubes rather than a single serpentine tube. Such a construction of the exhaust gas heater 21 minimizes the steam pressure drop in the exhaust gas heater 21. The exhaust gas heater 21 is located downstream of a catalytic converter 23 and upstream of a muffler 19 along the path of an exhaust gas pipe 20. This location of the exhaust gas heater 21 ensures that there is no adverse effect on the catalytic performance due to heat abstraction upstream of the catalytic converter.

To ensure safety of the system, the exhaust gas is allowed to flow only on the exterior of the exhaust gas heater 21 located inside the exhaust gas pipe 20. As such, it cannot enter the passenger compartment. Only the steam generated in the interior of the exhaust gas heater 21 enters the HVAC module of the motor vehicle where the vehicle heater 17 is located. The exhaust gas can enter the passenger compartment 18 only in the rare event of the exhaust gas heater 21 and vehicle heater 17 springing simultaneous leaks.

The cold fluid of the exhaust gas heater 21 is water, which is confined to circulate in a closed loop between the exhaust gas heater 21 and the steam side of the vehicle heater 17. The hot fluid of the exhaust gas heater 21 is the exhaust gas flowing on the exterior of the exhaust gas heater 21.

The conditioned (cold) fluid of the vehicle heating system is the ambient air, which is forced through the vehicle heater 17 to abstract heat from the steam as well as from the engine coolant. The process of heat abstraction by the ambient air from the two hot fluids in the vehicle heater 17 is somewhat involved. There is direct heat transfer between the air and the steam as well as between the air and the engine coolant. Also there is indirect heat transfer between the air and the steam. The steam being at a higher temperature than the engine coolant there is some direct heat transfer from the steam to the engine coolant. This steam-to-coolant heat transfer serves a two-fold purpose. Firstly, it raises the coolant temperature thereby increasing coolant-to-air heat transfer rate in the vehicle heater 17. Secondly, it serves to condense the steam on the steam side of the vehicle heater 17 thereby increasing the latent heat transfer from the exhaust gas to the condensed steam in the exhaust gas heater 21. Thus the vehicle heater 17 of the subject invention is particularly efficient.

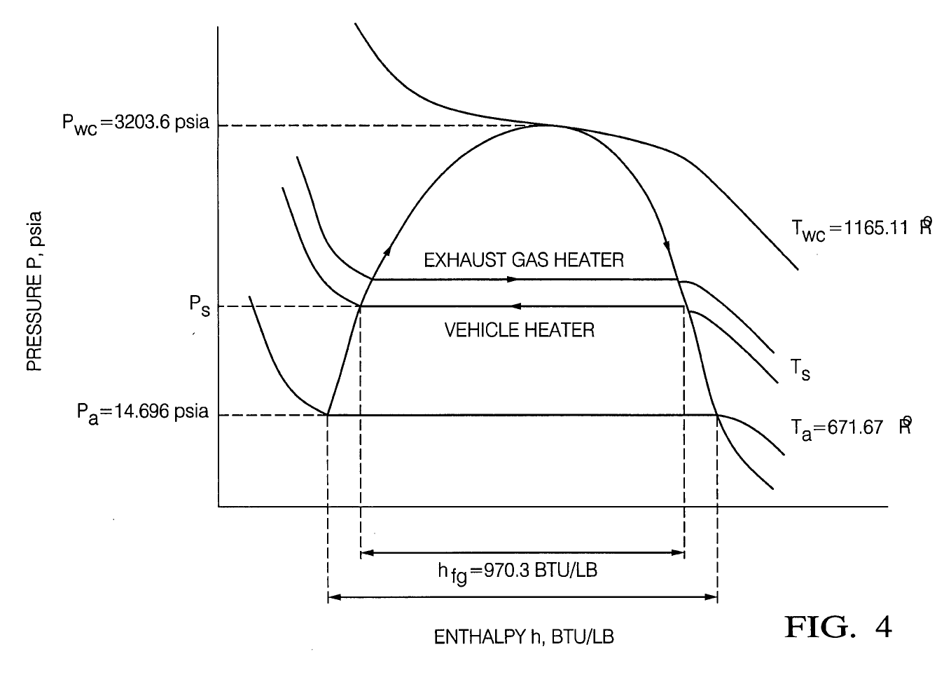

Operationally the steam heating process works like a thermosiphon pumping heat from the exhaust gas heater 21 to the vehicle heater 17 as indicated in FIG. 4 representing the heating cooling cycle on the pressure enthalpy diagram. The steam side of the thermosiphon is at elevated pressure depending on the temperature of the exhaust gas. The pressure drop on the steam side is relatively modest and therefore the internal pressure inside the steam portion of the vehicle heater 17 and the exhaust gas heater 21 is substantially constant but elevated of the order of 1000 psia depending on the exhaust gas temperature as indicated in FIG. 4.

As shown in FIG. 1, the heating system of the present invention is provided with the pair of shutoff valves 11 and 12 to isolate the exhaust gas heater 21 by trapping steam in the vehicle heater 17. This feature comes into play when comfort heating is not required as in summer time. Also this feature provides freeze protection in winter by allowing the liquid water to be trapped in the vehicle heater 17 when the vehicle is not running.

The exemplary heating system provides some degree of comfort heating immediately upon cold engine start up. This instantaneous heat is drawn from the exhaust gas as no heat can be drawn from the engine coolant. With cold start up, the engine coolant is not allowed to flow to the vehicle heater or to the radiator till it reaches a set temperature of about 200° F.

Another unique feature of the exemplary heating system is that it provides some degree of comfort heating during idling by drawing heat primarily from the engine coolant and only a moderate amount of heat from the exhaust gas. Under idling conditions, both the mass flow rate and temperature of exhaust gas fall off significantly resulting in significantly reduced heating. However, under these conditions, the engine coolant continues to provide fair amount of comfort heating due to large amount of thermal inertia of the engine coolant. Unlike exhaust gas, the engine coolant is forced to flow in a closed loop between the engine block on one side and heater 17 and radiator 8 on the other side. The closed loop flow of the engine coolant causes its thermal inertia to be large.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for heating ambient air for a passenger compartment of a motor vehicle comprising the steps of:
positioning a first heat exchanger proximate to a passenger compartment of a vehicle;
passing ambient air for the passenger compartment through a first heat exchanger; and
concurrently directing distinct flows of engine coolant and steam to the first heat exchanger to heat the ambient air.

2. The method of claim 1 further comprising the step of:
generating steam by transferring heat from engine exhaust to water in an exhaust gas heater.

3. The method of claim 2 further comprising the step of:
positioning the exhaust gas heater downstream of a catalytic converter.

4. The method of claim 2 further comprising the step of:
isolating the engine exhaust from the passenger compartment.

5. The method of claim 2 further comprising the step of:
arranging the exhaust gas heater as an array of nested U-tubes.

6. The method of claim 1 further comprising the step of:
moving the steam through a fluid circuit acting as a thermosiphon wherein higher pressure steam upstream of the first heat exchanger pushes lower pressure water vapor downstream of the first heat exchanger.

7. The method of claim 1 further comprising the step of:
directing the flows of coolant and steam through nested serpentine tubes.

8. The method of claim 7 further comprising the step of:
extending convoluted fins between adjacent serpentine tubes.

9. The method of claim 7 further comprising the step of:
directing the flows of coolant and steam in opposite directions through the nested serpentine tubes relative to one another.

10. The method of claim 1 further comprising the step of:
arranging the flows of coolant and steam in the first heat exchanger such that heat transfers from the steam to the coolant.

11. The method of claim 1 further comprising the step of:
disposing a pair of shut-off valves to trap water in the first heat exchanger to selectively stop the flow of water to the exhaust gas heater.
